(19) United States
(12) Patent Application Publication
(10) Pub. No.: US 2016/0183078 A1
(43) Pub. Date: Jun. 23, 2016

(54) WIRELESS COMMUNICATION DEVICE AND WIRELESS COMMUNICATION CONTROL METHOD

(71) Applicant: KABUSHIKI KAISHA TOSHIBA, Tokyo (JP)

(72) Inventor: Yutaka HORIE, Tokyo (JP)

(73) Assignee: KABUSHIKI KAISHA TOSHIBA, Tokyo (JP)

(21) Appl. No.: 14/816,408

(22) Filed: Aug. 3, 2015

Related U.S. Application Data
(60) Provisional application No. 62/095,592, filed on Dec. 22, 2014.

(51) Int. Cl. H04W 8/22; H04W 76/02; H04W 72/04; H04W 4/00

(52) U.S. Cl. CPC H04W 8/22; H04W 4/008; H04W 76/023; H04W 72/0406

(57) ABSTRACT

On embodiment provides a wireless communication device serving as one of plural wireless communication devices set as one group. The wireless communication device includes: a wireless communication portion configured to transmit and receive wireless signals; and a control portion connected to the wireless communication portion. When the wireless communication portion receives a first changeover signal from any other wireless communication device of the plural wireless communication devices, the control portion execute a suppressing control to suppress transmission of wireless signals in the wireless communication portion in response to the received changeover signal. And, when the wireless communication portion receives a second changeover signal from any other wireless communication device of the plural wireless communication devices during the suppressing control to suppress transmission of wireless signals, the control portion suspend the suppressing control in response to the received changeover signal.

### CROSS-REFERENCE TO RELATED APPLICATION(S)

This application claims priority from U.S. Provisional Patent Application No. 62/095,592 filed on Dec. 22, 2014, the entire contents of which are incorporated herein by reference.

### FIELD

An embodiment of the present invention relates to a wireless communication device and a wireless communication control method with a function of suppressing wireless transmission.

### BACKGROUND

In a radio-wave restricted zone such as an airplane or a hospital, communication by a wireless communication device with radio wave intensity not lower than predetermined intensity is restricted. Therefore, a communication restricted mode such as a flight mode is prepared in a wireless communication device such as a PC, a smartphone or a tablet.

As further miniaturization of wireless devices progresses, in the future, each user will carry larger number of wireless communication devices. As a result, a possibility that the user may forget to change over the wireless communication devices to a communication restricted mode in the radio-wave restricted zone increases. Similarly, as the user carries larger number of wireless communication devices, a possibility that the user may forget to change over all of them from the communication restricted mode to a normal mode and that any one of the devices may be left in the communication restricted mode also increases.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows examples of use forms of wireless communication devices according to an embodiment.

FIG. 2 shows an example of a hardware configuration of a wireless communication device according to the embodiment.

FIG. 3 shows examples of screens displayed by the wireless communication device according to the embodiment.

FIG. 4 shows an example of a processing flow executed by the wireless communication device according to the embodiment.

### DETAILED DESCRIPTION

Various embodiments will be described hereinafter with reference to the accompanying drawings.

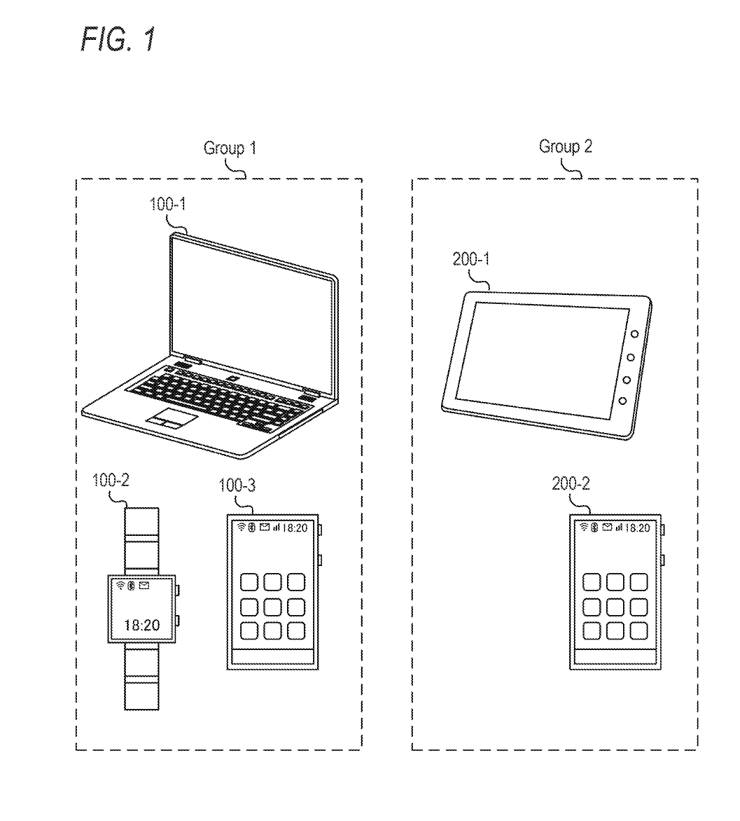

FIG. 1 is a schematic view showing use forms of wireless communication devices according to the embodiment. The wireless communication devices according to the embodiment are, for example, implemented as a personal computer (hereinafter referred to as PC) 100-1, a watch-type wearable device (hereinafter referred to as watch device) 100-2, a smartphone 100-3, a tablet 200-1, a smartphone 200-2, etc. Each device can operate in either a normal mode in which radio waves can be used normally and a restricted mode in which transmission of radio waves is restricted.

In the embodiment, the PC 100-1, the watch device 100-2 and the smartphone 100-3 are grouped as Group 1, and the tablet 200-1 and the smartphone 200-2 are grouped as Group 2. In each group, the modes of plural devices belonging to the same group can be linked with one another. For example, when the PC 100-1 is shifted from the normal mode to the restricted mode, the watch device 100-2 and the smartphone 100-3 are shifted to the same restricted mode. On the contrary, when the PC 100-1 is shifted from the restricted mode to the normal mode, the watch device 100-2 and the smartphone 100-3 are shifted to the normal mode. Specific configuration and processing of the embodiment will be described below.

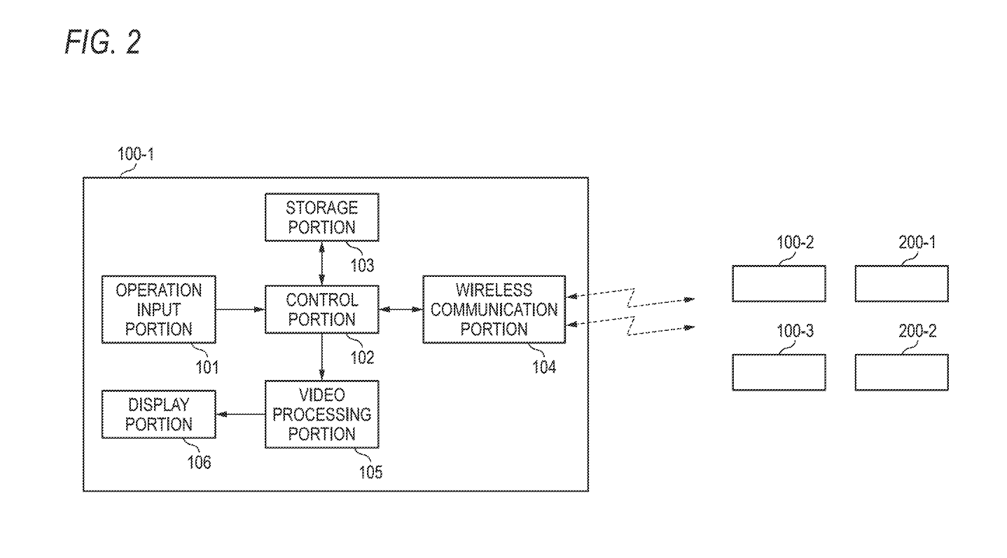

FIG. 2 shows an example of a hardware configuration of the PC 100-1. Each of the watch device 100-2, the smartphone 100-3, the tablet 200-1 and the smartphone 200-2 also has the configuration of the embodiment as in the PC 100-1. Thus, the PC 100-1 will be described mainly. On the other hand, operations of the watch device 100-2, the smartphone 100-3, the tablet 200-1 and the smartphone 200-2 are similar to that of PC 100-1.

The PC 100-1 has an operation input portion 101, a control portion 102, a storage portion 103, a wireless communication portion 104, a video processing portion 105 and a display portion 106. In FIG. 2, lines connecting those portions designate electric signal lines such as general communication buses, dedicated signal lines, etc. The operation input portion 101 is a module that accepts an operation from a user.

For example, the operation input portion 101 may include a keyboard, a touch panel, a wireless kill switch, etc. The operation input portion 101 accepts an operation for setting a group, an operation for changing over a wireless mode, etc. A keyboard controller or a touch panel controller for controlling the keyboard or the kill switch is not shown.

The control portion 102 is, for example, a CPU, which controls respective constituents of the PC 100-1 and executes various software processings. When the operation input portion 101 receives an operation for setting a group, the control portion 102 executes group setting in accordance with the received operation. On the other hand, in response to an operation for changing over the wireless mode, the control portion 102 controls the wireless communication portion 104 to transmit a changeover signal to devices belonging to the same group as the PC 100-1, and changes over the wireless mode of the PC 100-1. When receiving a changeover signal from another device, the control portion 102 determines whether the device transmitting the signal belongs to the same group as the PC 100-1 or not. When the device belongs to the same group, the control portion 102 changes over the wireless mode of the PC 100-1.

The changeover signal includes information indicating which mode to shift to, the restricted mode or the normal mode, and an identifier of a device transmitting the changeover signal. The control portion 102 recognizes the device identifier included in the changeover signal and identifying the device transmitting the changeover signal. When the recognized device identifier has been registered in the storage portion 103 as the same group, the wireless mode is shifted to the restricted mode or the normal mode in accordance with the changeover signal. The changeover signal may include not only the identifier of the device transmitting the changeover signal but also information of devices to be controlled.

That is, for example, when a group identifier is given to each group, a device that is to transmit a changeover signal transmits a changeover signal including a group ID, and a device that receives the changeover signal determines whether the group ID included in the changeover signal coincides with an ID of the self group, or not. When the group ID coincides, the PC 100-1 shifts its wireless mode to the restricted mode or the normal mode in accordance with an instruction of the changeover signal.

Alternatively, the changeover signal may include identifiers of devices to be controlled. In this case, a device receiving a changeover signal determines whether an identifier of the device is included in the received signal or not. When the identifier is included, the device shifts its wireless mode to the restricted mode or the normal mode in accordance with an instruction of the changeover signal. Further, the changeover signal may include information of a continuing period of a mode. For example, when a changeover signal indicates shifting to the restricted mode and one hour, a device receiving the changeover signal continues the restricted mode for one hour and then returns to the normal mode.

The control portion 102 may determine whether to permit changeover between the normal mode and the restricted mode depending on setting by a user. For example, the PC 100-1 may operates to permit a changeover signal from the watch device 100-2, but not to permit a changeover signal from the smartphone 100-3.

The storage portion 103 is a storage device that is connected to the CPU through a bus. The storage portion 103 stores information as to group setting set by the control portion 102. The wireless communication portion 104 is connected to the control portion 102 through a bus. The wireless communication portion 104 executes wireless communication with another device. For example, the wireless communication portion 104 may include a wireless LAN module compliant with IEEE 802.11, a Bluetooth module, a mobile communication module, an NFC (Near Field Communication) module, etc. Those communication modules are formed into chips, and each module is connected to an antenna.

The wireless communication portion 104 has a function of transmitting/receiving a changeover signal directly with a partner device or indirectly through an access point, a base station, an external server, or the like.

Under the control of the control portion 102, the wireless communication portion 104 executes a reception operation while suppressing transmission intensity of wireless transmission to be not higher than predetermined intensity in the restricted mode.

In the normal mode, the wireless communication portion 104 suspends the suppression in the restricted mode and executes both wireless transmission and reception. When plural wireless methods such as mobile communication, wireless LAN, Bluetooth, NFC, etc. are available in the PC 100-1, the control portion 102 may make control not to restrict wireless transmission in NFC but to restrict wireless transmission in mobile communication, wireless LAN and Bluetooth.

The video processing portion 105 is a GPU for generating an image signal to be displayed on the display portion 106. The video processing portion 105 may be formed into a chip separated from the control portion 102 and connected to the control portion 102 through a bus, or may be formed into one and the same chip together with the control portion 102.

The display portion 106 is a liquid crystal display or an organic EL display that receives an output of an image signal from the video processing portion 105 and displays a video image using the received signal.

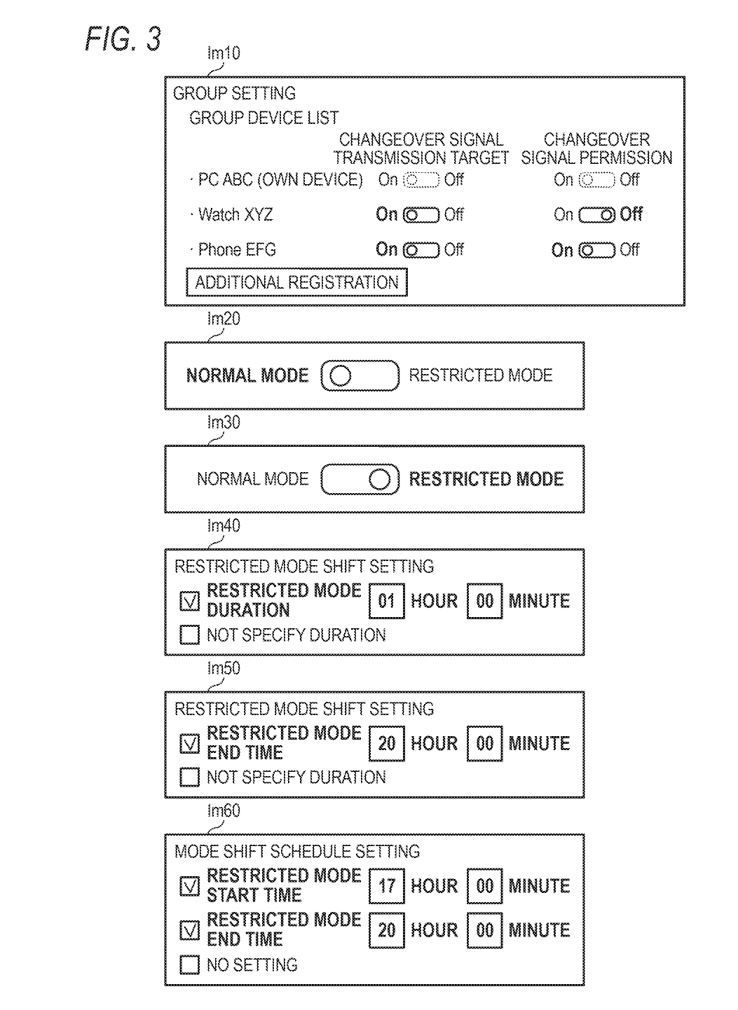

FIG. 3 shows examples of screens displayed by the PC 100-1. In the same manner as the description in FIG. 2, description will be made on the assumption that processing for displaying the screens in FIG. 3 and various processings accompanied by the screen display are executed by the PC 100-1. However, those processings are also executed in the other devices, that is, the watch device 100-2, the smartphone 100-3, the tablet 200-i and the smartphone 200-2.

A screen Im10 is an example of a group setting screen. In the group setting screen, plural names of devices registered in that group are displayed. For example, PC ABC (own device, the PC 100-1), Phone EFG (the smartphone 100-3) and Watch XYZ (the watch device 100-2) are displayed. These devices have been registered in one and the same group.

The screen Im10 provides the user with an option of setting for each device as to whether to set the device as a target to which a changeover signal should be transmitted and whether to permit the device to perform changeover processing in accordance with the changeover signal when the device receives the changeover signal. When the operation input portion 101 of the PC 100-1 receives a changeover operation from a user, the PC 100-1 transmits a changeover signal to a device set on the screen Im10 as a target to which a changeover signal should be transmitted. In the setting example shown in the screen Im10, the PC 100-1 is set not to permit a changeover signal from the smartphone 100-3 but to permit a changeover signal from the watch device 100-2.

Therefore, when receiving a changeover signal from the watch device, the PC 100-1 executes changeover processing in accordance with the received changeover signal. However, when receiving a changeover signal from the smartphone 100-3, the PC 100-1 does not execute changeover processing in response to the received changeover signal, or does not execute changeover processing as long as an approval operation from the user cannot be obtained on an approval screen displayed for the user.

An additional registration button is also displayed on the screen so that a new device can be registered in the group in accordance with an operation input on the button.

For example, processing for the additional registration is carried out by the user who operates and inputs an identifier unique to the device to be registered. It is considered that a MAC address, an IP address, a Bluetooth address or the like may be used as the identifier. However, if mode changeover control is carried out under the control of an application program, an independent identifier the application program gives to each device may be used as the identifier.

When a new device to be added to the group is inputted to the PC 100-1, the PC 100-1 transmits registration information to the new device. The registration information includes identifiers of devices that have been already registered in the group and/or a group identifier for identifying the group. When the new device approves the registration information, the new device stores the identifiers of the other devices belonging to the group based on the received registration information. When the group identifier is included in the registration information, the new device also stores the group identifier. The new device then notifies each device in the group of its own identifier. Thus, each device recognizes the fact that the new device has been registered in the group. In each device that has received the notification, the identifier of the new device is stored in the storage portion 103 as one of identifiers of devices registered in the group.

In another example of the registration processing, a group identifier of a group is inputted in a new device that should be added to the group, so that the new device can be registered in the group. On this occasion, the new device transmits a registration request including a group identifier and its own device identifier to the other devices that have been already registered in the group.

A method for transmitting the registration request to the other devices that have been already registered in the group may be a method in which the registration request is broadcast to the other devices, a method in which a server for managing the group is prepared in advance and the registration request is transmitted to the other devices via the server, or the like. When the former method is used, the new device must recognize device identifiers of the other devices in advance by some means.

When another device that has been already registered in the group receives the registration request including the group identifier of the group in which the device itself has been registered, the device registers the identifier of the new device included in the registration request as one of identifiers of devices belonging to the group and transmits, to the new device, the device identifiers of the devices belonging to the group. The new device registers the received device identifiers.

Screens Im20 and Im30 are examples of operation screens for changing over the mode between the normal mode and the restricted mode. In each of the screens, an image of a radio button imitating a kill switch is displayed. When the image is slid, the mode can be changed over.

When an operation for changing over the mode is received in the screen Im20 or Im30, the kill switch, etc., a time setting screen as shown in a screen Im40 or Im50 may be displayed following an input for deciding the received operation. The time when the shifted mode should be continued is set on the time setting screen. In an example of the screen Im40, setting of continuing the restricted mode for an hour is made. In an example of the screen Im50, setting of continuing the restricted mode until 20:00 is made.

When the setting shown in the screen Im40 is decided by the PC 100-1, the control portion 102 of the PC 100-1 transmits, from the wireless communication portion 104, a changeover signal including an instruction to shift to the restricted mode and information indicating that the restricted mode should be continued for one hour.

When one hour has passed since the mode was shifted to the restricted mode, the PC 100-1 returns to the normal mode. The watch device 100-2 and the smartphone 100-3 receive the changeover signal and shift their mode to the restricted mode. Based on the information of “one hour” indicated by the changeover signal, the watch device 100-2 and the smartphone 100-3 return to the normal mode when one hour has passed. When the setting shown in the screen Im40 is decided, the PC 100-1 may transmit a changeover signal not including information as to the time when the restricted mode should be continued, and after one hour transmit a changeover signal for giving an instruction to shift to the normal mode.

When the setting shown in the screen Im50 is decided by the PC 100-1, the PC 100-1 transmits a changeover signal including an instruction to shift to the restricted mode and information indicating that the restricted mode should be continued until 20:00. The PC 100-1 continues the restricted mode until 20:00. The watch device 100-2 and the smartphone 100-3 receiving the changeover signal also continue the restricted mode until 20:00. When the setting shown in the screen Im50 is decided, the PC 100-1 may transmit a changeover signal not including information as to the time when the restricted mode should be continued, and then at 20:00 transmit a changeover signal giving an instruction to shift to the normal mode.

Both the start time of a mode and the end time of the mode may be set as shown in a screen Im60. When the setting on the screen Im60 is carried out, the PC 100-1 transmits a changeover signal including an instruction to start the restricted mode at 17:00 and return to the normal mode at 20:00. The PC 100-1 itself starts the restricted mode at 17:00 and returns to the normal mode at 20:00. The watch device 100-2 and the smartphone 100-3 receiving the changeover signal start the restricted mode at 17:00 and return to the normal mode at 20:00 in the same manner.

Although there has been exemplified a case in which a changeover signal giving an instruction for the start time and the end time is transmitted when the setting on the screen Im60 is made, the PC 100-1 may transmit a changeover signal giving an instruction to shift to the restricted mode at 17:00 and transmit a changeover signal giving an instruction to shift to the normal mode at 20:00.

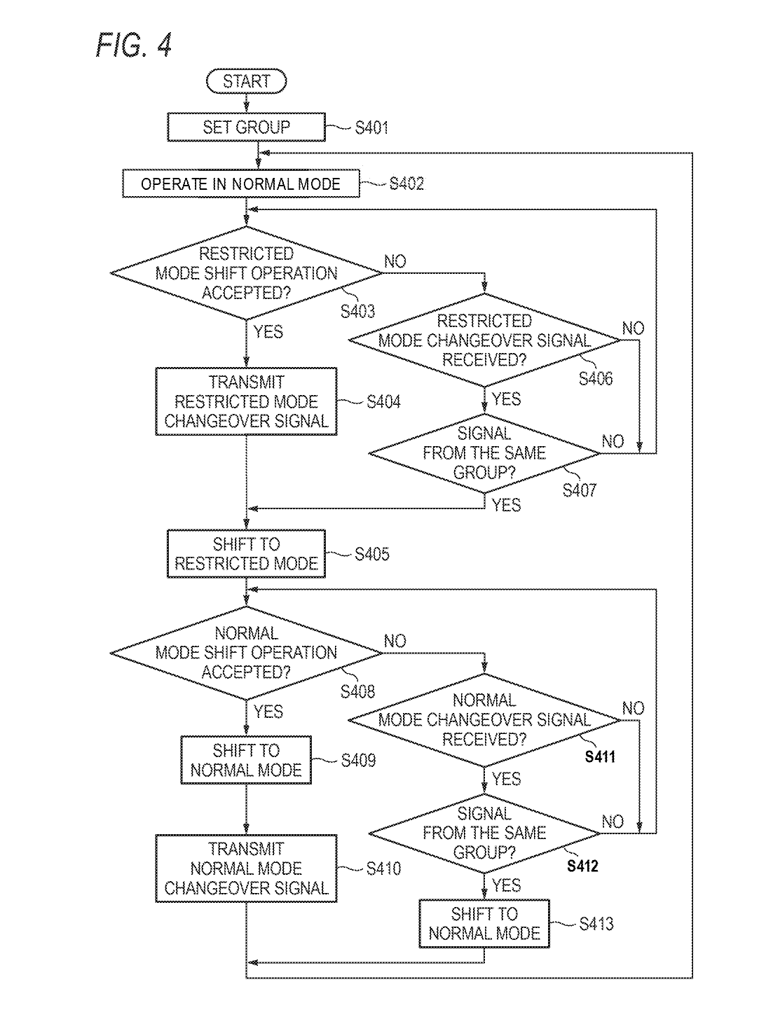

FIG. 4 shows an example of a flow of processing to be executed by the PC 100-1. This processing is also executed by the other devices. First, the PC 100-1 performs the group setting described in FIG. 3 for synchronizing a radio wave transmission mode among itself and the other devices in the group (S401). Assuming that the PC 100-1, the watch device 100-2 and the smartphone 100-3 have been registered in one and the same group.

Assuming that the radio wave transmission mode is a normal mode (S402). In this case, when an operation to shift to a radio wave restricted mode is inputted to the operation input portion 101 and accepted by the control portion 102 (Yes in S403), the wireless communication portion 104 transmits, to the watch device 100-2 and the smartphone 100-3, a changeover signal giving an instruction to change over to the radio wave restricted mode (S404). The wireless communication portion 104 may transmit the changeover signal by broadcast transmission specifying no destination or transmit the changeover signal specifying the watch device 100-2 and the smartphone 100-3 as destinations. After transmitting the changeover signal, the control portion 102 shifts the PC 100-1 to the radio wave restricted mode (S405).

When the wireless communication portion 104 receives a changeover signal from another device (Yes in S406) in the case where the control portion 102 receives no operation in 5403, the control portion 102 determines whether the received signal is a signal targeting at Group 1 or not (S407). When its own device is included in the control target of the changeover signal (Yes in S407), the control portion 102 shifts the PC 100-1 to the restricted mode to restrict transmission of wireless signals in the wireless communication portion 104 (S405). In S407, the control portion 102 may determine whether the changeover signal is or not a signal from a device whose changeover signal is permitted, so that whether to execute restriction of transmission or not can be determined in accordance with the result of the determination as described in FIG. 3.

When the operation input portion 101 accepts, during the restricted mode, an operation to shift to the normal mode (Yes in S408), the control portion 102 shifts to the normal mode and releases the wireless communication portion 104 from the restriction of transmission (S409). The control portion 102 transmits, to the watch device 100-2 and the smartphone 100-3, a changeover signal giving an instruction to shift to the normal mode (S410), and returns to processing of S401 or S402.

When the wireless communication portion 104 receives, during the restricted mode, a changeover signal giving an instruction to shift to the normal mode (Yes in S411), the control portion 102 determines whether the received changeover signal is a signal from a device belonging to the same group or not (S412). The control portion 102 may determine whether the received changeover signal is a signal from a device whose changeover signal is permitted or not, as described in FIG. 3. When the received changeover signal is a changeover signal from the same group (Yes in S412), the control portion 102 shifts to the normal mode and releases the wireless communication portion 104 from the restriction of transmission (S413). Then the control portion 102 returns to processing of S401 or S402.

This processing flow is also executed in any other device, as described above. Therefore, for example, the PC 100-1 may transmit a changeover signal to the other devices in response to an operation to shift to the restricted mode while the watch device 100-2 transmits a changeover signal to the other devices in response to an operation to return from the restricted mode to the normal mode.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A wireless communication device serving as one of plural wireless communication devices set as one group, comprising:
a wireless communication portion configured to transmit and receive wireless signals; and
a control portion
connected to the wireless communication portion, and
configured to,
when the wireless communication portion receives a first changeover signal from any other wireless communication device of the plural wireless communication devices, execute a suppressing control to suppress transmission of wireless signals in the wireless communication portion in response to the received changeover signal, and
when the wireless communication portion receives a second changeover signal from any other wireless communication device of the plural wireless communication devices during the suppressing control, suspend the suppressing control in response to the received changeover signal.

2. The wireless communication device according to claim 1, further comprising:
an operation acceptance portion configured to accept an operation input from a user,
wherein, when a first operation input giving an instruction to execute the suppressing control is accepted by the operation acceptance portion, the control portion causes the wireless communication portion to transmit the first changeover signal targeted at controlling at least one wireless communication device belonging to the plural wireless communication devices in response to the accepted operation, and executes the suppressing control after transmitting the first changeover signal.

3. The wireless communication device according to claim 1, further comprising:
an operation acceptance portion configured to accept an operation input from a user,
wherein, when a second operation input giving an instruction to suspend the suppressing control is accepted by the operation acceptance portion during the suppressing control, the control portion causes the wireless communication portion to transmit the second changeover signal targeted at controlling at least one wireless communication device belonging to the plural wireless communication devices.

4. The wireless communication device according claim 3,
wherein, when the second operation input is accepted by the operation acceptance portion, the control portion suspends the suppressing control and causes the wireless communication portion to transmit the second changeover signal after suspending the suppressing control.

5. The wireless communication device according to claim 1,
wherein, in response to the first changeover signal from a first wireless communication device belonging to the plural wireless communication devices, the control portion executes the suppressing control, and the control portion suspends the suppressing control in response to the second changeover signal from a second wireless communication device of the plural wireless communication devices different from the first wireless communication device.

6. The wireless communication device according to claim 1,
wherein the wireless communication portion includes
a first wireless communication portion using a first wireless communication method and
a second wireless communication portion using a second wireless communication method, and
wherein, during the suppressing control, the control portion does not suppress transmission in the second wireless communication portion but suppresses transmission in the first wireless communication portion.

7. The wireless communication device according to claim 6,
wherein the first wireless communication method is one of a mobile communication, a wireless LAN and a Bluetooth, and the second wireless communication method is an NFC.

8. The wireless communication device according to claim 1, further comprising:
a storage portion configured to store identification information of the plural communication devices as identification information of devices registered in the group,
wherein, when the identification information stored in the storage portion is included in the first changeover signal or the second changeover signal, the control portion changes over control of transmission in the wireless communication portion in response to the first changeover signal or the second changeover signal.

9. The wireless communication device of claim 1, further comprising:
a storage portion configured to store a group ID assigned to the group,
wherein, when the group ID stored in the storage portion is included in the first changeover signal or the second changeover signal, the control portion changes over control of transmission in the wireless communication portion in response to the first changeover signal or the second changeover signal.

10. The wireless communication device of claim 1,
wherein, when the wireless communication portion receives the first changeover signal indicating time information, the control portion executes the suppressing control for a period corresponding to the time information indicated by the first changeover signal.

11. The wireless communication device of claim 1, further comprising:
an operation acceptance portion configured to accept an operation input from a user,
wherein, when the operation acceptance portion accepts an operation input as to a time, the control portion causes the wireless communication portion to transmit the first changeover signal or the second changeover signal including time information indicating the time.

12. A communication control method for a first wireless communication device serving as one of plural wireless communication devices set as one group,
each of the plural wireless communication devices comprising:
a wireless communication portion configured to transmit and receive wireless signals; and
a control portion connected to the wireless communication portion, the communication control method comprising:
when the wireless communication portion of the first wireless communication device receives a first changeover signal from any other wireless communication device of the plural wireless communication devices, executing a suppressing control to suppress transmission of wireless signals in the wireless communication portion of the wireless communication portion in response to the received changeover signal; and
when the wireless communication portion of the first wireless communication device receives a second changeover signal from any other wireless communication device of the plural wireless communication devices during the suppressing control, suspending the suppressing control in response to the received changeover signal.
